(19) United States
(12) Patent Application Publication
(10) Pub. No.: US 2005/0243887 A1
(43) Pub. Date: Nov. 3, 2005

(54) DBR using the combination of II-VI and III-V materials for the application to 1.3-1.55 mum

(75) Inventor: Hoki Kwon, Plymouth, MN (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignees: Honeywell International Inc.; Finisar Corporation

(21) Appl. No.: 10/836,165

(22) Filed: Apr. 30, 2004

(51) Int. Cl. H01S 3/08

(52) U.S. Cl. 372/99; 372/43.01; 372/50.1

(57) ABSTRACT

A VCSEL includes a substrate; a first mirror stack over the substrate; an active region having a plurality of quantum wells over the first mirror stack; and a second mirror stack over the active region, wherein either or both of the first and second mirror stacks include alternating layers of II-VI and III-V compounds, and wherein said II-VI compound is selected from the group consisting of ZnCdSe, ZnSeTe and ZnMgSe, and said III-V compound is selected from the group consisting of InGaAsP, InAlGaAs and InP. Such a mirror stack is especially useful for a long-wavelength VCSEL.

### CROSS-REFERENCE TO RELATED APPLICATIONS

Not applicable.

### BACKGROUND OF THE INVENTION

1. Field of the Invention

This invention relates to vertical cavity surface emitting lasers (VCSELs). More specifically, it relates to distributed Bragg reflector (DBR) mirrors for VCSELs.

2. Discussion of the Related Art

Vertical cavity surface emitting lasers (VCSELs) represent a relatively new class of semiconductor lasers. While there are many VCSEL variations, a common characteristic is that VCSELs emit light perpendicular to a semiconductor wafer's surface. Advantageously, VCSELs can be formed from a wide range of material systems to produce specific characteristics.

VCSELs include semiconductor active regions, distributed Bragg reflector (DBR) mirrors, current confinement structures, substrates, and contacts. Because of their complicated structure, and because of their specific material requirements, VCSELs are usually grown using metal-organic chemical vapor deposition (MOCVD) or molecular beam epitaxy (MBE).

FIG. 1 illustrates a typical long-wavelength VCSEL 10. As shown, an n-doped InP substrate 12 has an n-type electrical contact 14. An n-doped lower mirror stack 16 (a DBR) is on the InP substrate 12, and an n-type graded-index InP lower spacer 18 is disposed over the lower mirror stack 16. An InGaAsP or AlInGaAs active region 20, usually having a number of quantum wells, is formed over the InP lower spacer 18. Over the active region 20 is an insulating region 40 that provides current confinement. The insulating region 40 is usually formed either by implanting protons or by forming an oxide layer. In any event, the insulating region 40 defines a conductive annular central opening 42 that forms an electrically conductive path though the insulating region 40. Over the insulating region is a tunnel junction 28. Over the tunnel junction 28 is an n-type graded-index InP top spacer 22 and an n-type InP top mirror stack 24 (another DBR), which is disposed over the InP top spacer 22. Over the top mirror stack 24 is an n-type conduction layer 9, an n-type cap layer 8, and an n-type electrical contact 26.

Still referring to FIG. 1, the lower spacer 18 and the top spacer 22 separate the lower mirror stack 16 from the top mirror stack 24 such that an optical cavity is formed. As the optical cavity is resonant at specific wavelengths, the mirror separation is controlled to resonate at a predetermined wavelength (or at a multiple thereof).

In operation, an external bias causes an electrical current 21 to flow from the electrical contact 26 toward the electrical contact 14. The tunnel junction over the insulating region 40 converts incoming electrons into holes. The converted holes are injected into the insulating region 40 and the conductive central opening 42, both of which confine the current 21 such that the current flows through the conductive central opening 42 and into the active region 20. Some of the injected holes are converted into photons in the active region 20. Those photons bounce back and forth (resonate) between the lower mirror stack 16 and the top mirror stack 24. While the lower mirror stack 16 and the top mirror stack 24 are very good reflectors, some of the photons leak out as light 23 that travels along an optical path. Still referring to FIG. 1, the light 23 passes through the conduction layer 9, the cap layer 8, an aperture 30 in electrical contact 26, and out of the surface of the vertical cavity surface emitting laser 10.

It should be understood that FIG. 1 illustrates a typical long-wavelength VCSEL having a tunnel junction, and that numerous variations are possible. For example, the dopings can be changed (say, by providing a p-type substrate), different material systems can be used, operational details can be tuned for maximum performance, and additional structures and features can be added.

While generally successful, the conventional long-wavelength VCSELs have problems with DBRs. Thus, it is beneficial to consider DBRs in more detail. A DBR in VCSELs is formed by depositing 30 to 50 alternating layers of different transparent materials. Each layer is one quarter of a wavelength thick and the index of refraction is different for the two materials. In general, there are three main requirements for DBR materials. First, the two materials stacked must have significantly different indices of refraction (high refractive index contrast) to achieve high reflectivity to reduce optical losses. Second, the materials must be compatible with the substrate used to grow the active region. Third, the materials should be thermally conductive as well to dissipate the heat build-up during the operation of VCSELs. One problem in realizing commercial quality long-wavelength VCSELs is lack of proper DBR material to meet those requirements.

While the optical performance of a DBR comprised of AlAs and GaAs is very good, it is beneficial to use an InP substrate to produce a VCSEL that emits a long wavelength. Unfortunately, because of the high degree of lattice mismatch between AlAs/GaAs and InP, it is very difficult to produce a high quality AlAs/GaAs DBR on an InP substrate. In addition to AlAs/GaAs material systems, other DBR mirror material systems, including InGaAsP/InP and InAlGaAs/InAlAs are known. However, due to their low refractive index contrast, more than 40 to 50 pairs are required to achieve high reflectivity at 1.3-1.55 μm (long-wavelength VCSELs).

Therefore, a new material system suitable for use in VCSEL DBRs, particularly at long wavelengths, would be beneficial.

### BRIEF SUMMARY OF THE INVENTION

Accordingly, the present invention is directed to a new distributed Bragg reflector (DBR) material system suitable for use in long wavelength VCSELs that substantially obviates one or more of the problems due to limitations and disadvantages of the prior art.

A principle of the present invention is to provide a DBR material system with a high refractive contrast that can be fabricated on an InP substrate. A DBR according to the principles of the present invention includes a plurality of alternating layers of a II-VI compound selected from the group consisting of ZnCdSe, ZnSeTe, and ZnMgSe and a III-V compound selected from the group consisting of InGaAsP, InAlGaAs, and InP. Due to their high refractive index contrast, the number of DBR pairs to achieve a high reflectivity for good VCSELs is reduced. Such DBRs are particularly advantageous for long-wavelength VCSELs.

In order to achieve these and other advantages and in accordance with the purpose of the present invention, as embodied and broadly described, a vertical cavity surface emitting laser may, for example, include a substrate; a first mirror stack over the substrate; an active region having a plurality of quantum wells over the first mirror stack; and a second mirror stack over the active region, wherein either or both of the first and second mirror stacks include alternating layers of II-VI and III-V compounds, and wherein said II-VI compound is selected from the group consisting of ZnCdSe, ZnSeTe and ZnMgSe, and said III-V compound is selected from the group consisting of InGaAsP, InAlGaAs and InP.

In another aspect of the present invention, a long-wavelength VCSEL may, for example, include an indium-based semiconductor alloy substrate; a first mirror stack over the substrate; an active region having a plurality of quantum wells over the first mirror stack; and a second mirror stack over the active region, wherein either or both of the first and second mirror stacks include alternating layers of II-VI and III-V compounds, and wherein said II-VI compound is selected from the group consisting of ZnCdSe, ZnSeTe and ZnMgSe, and said III-V compound is selected from the group consisting of InGaAsP, InAlGaAs and InP.

Additional features and advantages of the invention will be set forth in the description that follows, and in part will be apparent from that description, or may be learned by practice of the invention.

### BRIEF DESCRIPTION OF THE DRAWING

The accompanying drawings, which are included to provide a further understanding of the invention and which are incorporated in and constitute a part of this specification, illustrate embodiments of the invention and together with the description serve to explain the principles of the invention.

In the drawings:

FIG. 1 illustrates a typical long-wavelength vertical cavity surface emitting laser (VCSEL);

FIG. 2 illustrates a long-wavelength VCSEL that is in accord with the principles of the present invention;

FIG. 3 illustrates a lower mirror stack (DBR) that is in accord with the principles of the present invention; and

FIG. 4 illustrates a top mirror stack (DBR) that is in accord with the principles of the present invention.

Note that in the drawings that like numbers designate like elements. Additionally, for explanatory convenience the descriptions use directional signals such as up and down, top and bottom, and lower and upper. Such signals, which are derived from the relative positions of the elements illustrated in the drawings, are meant to aid the understanding of the present invention, not to limit it.

### DETAILED DESCRIPTION OF THE ILLUSTRATED EMBODIMENT

Reference will now be made in detail to an embodiment of the present invention, example of which is illustrated in the accompanying drawings. Embodiments of the invention are described with reference to II-VI compounds and III-V compounds. One of skill in the art can appreciate that embodiments of the invention are not limited to II-VI compounds such as ZnCdSe, ZnSeTe, and ZnMgSe or to III-V compounds such as InGaAsP, InAlGaAs, and InP. Rather, embodiments of the invention extend to other compounds (and other compound groups) that are lattice compatible with a substrate and that have a high refractive index contrast as described herein.

A principle of the present invention is to provide a DBR material system with a high refractive contrast that can be fabricated on an InP substrate. A DBR according to the principles of the present invention includes a plurality of alternating layers of a II-VI compound selected from the group consisting of ZnCdSe, ZnSeTe, and ZnMgSe and a III-V compound selected from the group consisting of InGaAsP, InAlGaAs, and InP. Due to their high refractive index contrast, the number of DBR pairs to achieve the high reflectivity for long-wavelength VCSELs is reduced. Such DBRs are particularly advantageous for long-wavelength VCSEL applications.

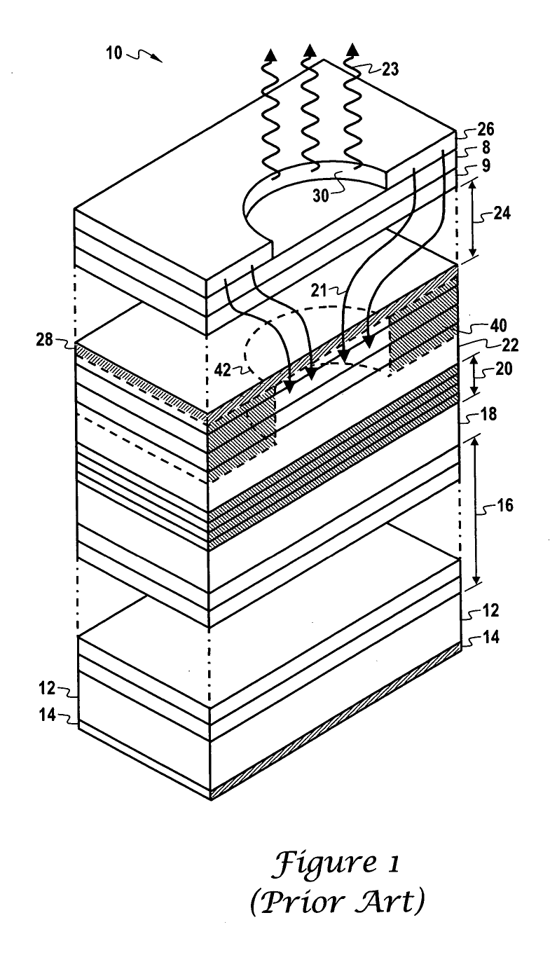

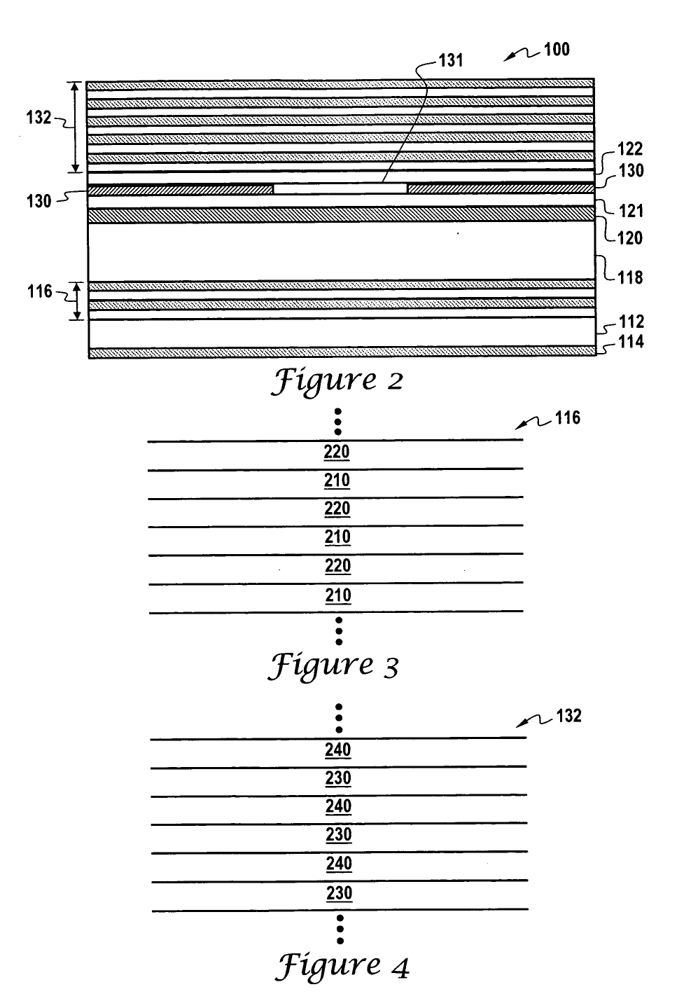

The principles of the present invention are now incorporated in an embodiment of a long-wavelength VCSEL having an InP substrate. An example of such a VCSEL is the VCSEL 100 illustrated in FIG. 2. FIG. 2 should be understood as a simplified “cut-away” schematic depiction of a VCSEL that is generally configured as shown in FIG. 1. However, the VCSEL 100 includes novel and useful top and bottom distributed Bragg reflectors (DBRs).

Referring to FIGS. 2 and 3, the VCSEL 100 includes an n-doped indium phosphorus (InP) substrate 112 having an n-type electrical contact 114. An n-doped lower mirror stack 116 (a DBR) comprised of a plurality of alternating layers of a II-VI compound 220 and a III-V compound 210 is over the InP substrate 112. The II-VI compound is selected from the group consisting of ZnCdSe, ZnSeTe, and ZnMgSe. Also, the III-V compound is selected from the group consisting of InGaAsP, InAlGaAs, and InP. The lower mirror stack 116 is beneficially grown on the InP substrate using, for example, hydride sources like TBA and TBP with high cracking efficiency at a temperature less than 600° C. in an Metal Organic Chemical Vapor Deposition (MOCVD) process, with the alternating layers being lattice-matched to the InP substrate, because II-VI requires lower growth temperature than III-V. During the MOCVD process, a special purge scheme such as short H₂ or group V gas purge between the alternating layers may be applied in order to improve the interface quality between the two alternating layers and to prevent cross-contamination. However, it should be understood that the DBR with a plurality of alternating layers of II-VI and III-V compounds that is in accord with the principles of the present invention can also be grown using Molecular Beam Epitaxy (MBE) method.

Over the lower mirror stack 116 is an n-doped InP spacer 118 grown beneficially using MOCVD. An active region 120 having P-N junction structures with a number of quantum wells is formed over the lower spacer 118. The composition of the active region 120 is beneficially InAlGaAs, InGaAsP, or InP. The active region could be comprised of alternating material layers, depending on how the quantum wells are within the active region 120. Over the active region 120 is a p-type InP top spacer 121. Similar to the lower InP spacer 118, the p-type InP top spacer 121 is also grown using MOCVD. Over the p-type InP top spacer 121 is an insulating region 130 and a conductive annular central opening 131 that provide current confinement. Over the insulating region is a tunnel junction 122.

Referring to FIGS. 2 and 4, over the tunnel junction 122 is an n-type top mirror stack 132 (another DBR). As in the case of the lower mirror stack 116, the n-type top mirror stack 132 is beneficially comprised of a plurality of alternating layers of a II-VI compound 240 and a III-V compound 230. The II-VI compound is selected from the group consisting of ZnCdSe, ZnSeTe, and ZnMgSe. Also, the III-V compound is selected from the group consisting of InGaAsP, InAlGaAs, and InP. As in the case of the lower mirror stack 116, the top mirror stack 132 is beneficially grown on the InP substrate using, for example, hydride sources like TBA and TBP with high cracking efficiency at a temperature less than 600° C. in an Metal Organic Chemical Vapor Deposition (MOCVD) process, with the alternating layers being lattice-matched to the InP substrate, because II-VI requires lower growth temperature than III-V. During the MOCVD process, a special purge scheme such as short H₂ or group V gas purge between the alternating layers may be applied in order to improve the interface quality between the two alternating layers and to prevent cross-contamination.

With the top mirror stack 132 formed, an n-type conduction layer (similar to the p-type conduction layer 9 of FIG. 1), an n-type GaAs cap layer (similar to the p-type GaAs cap layer 8 of FIG. 1), and an n-type electrical contact (similar to the p-type electrical contact 26 of FIG. 1) may be provided to complete the VCSEL 100.

The VCSEL 100 of FIG. 2 differs significantly from the VCSEL 10 of FIG. 1 because the VCSEL 100 incorporates a lower mirror stack 116 and a top mirror stack 124 (DBRs) that are comprised of a plurality of alternating layers of II-VI and III-V compounds. The II-VI compound is selected from the group consisting of ZnCdSe, ZnSeTe, and ZnMgSe. Also, the III-V compound is selected from the group consisting of InGaAsP, InAlGaAs, and InP. According to the principles of the present invention, several embodiments are possible to form a long-wavelength VCSEL by replacing either the lower mirror stack 116 or the top mirror stack 132, or by replacing both of the mirror stacks with a plurality of alternating layers of II-VI and III-V compounds.

The VCSEL 100 having a DBR constructed according to the principles of the present invention has significant advantages over prior art VCSELs. A smaller number of DBR layers is required to obtain the required high reflectivity due to high refractive index contrast, compared with the conventional long-wavelength VCSELs, which enables productive fabrication techniques, reduced cost, and better throughput and performance.

The embodiments and examples set forth herein are presented to explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

1. A vertical cavity surface emitting laser, comprising:
a substrate;
a first mirror stack over the substrate;
an active region having a plurality of quantum wells over the first mirror stack; and
a second mirror stack over the active region,
wherein either or both of the first and second mirror stacks include alternating layers of II-VI and III-V compounds, and wherein said II-VI compound is selected from the group consisting of ZnCdSe, ZnSeTe and ZnMgSe, and said III-V compound is selected from the group consisting of InGaAsP, InAlGaAs and InP.

2. A vertical cavity surface emitting laser according to claim 1, further including a current confinement structure over the active region.

3. A vertical cavity surface emitting laser according to claim 2, wherein the current confinement structure includes an insulating region and a conductive annular center.

4. A vertical cavity surface emitting laser according to claim 2, further including a tunnel junction over the current confinement structure.

5. A vertical cavity surface emitting laser according to claim 1, wherein the alternating layers of II-VI and III-V compounds are grown by a MOCVD method using hydride sources like TBA and TBP at a temperature less than 600° C.

6. A vertical cavity surface emitting laser according to claim 1, wherein the alternating layers of II-VI and III-V compounds are grown by a MBE method.

7. A vertical cavity surface emitting laser according to claim 4, wherein the first and second mirror stacks are an n-type DBR.

8. A vertical cavity surface emitting laser according to claim 7, wherein the active region includes one of InGaAsP, AlInGaAs, and InP.

9. A long-wavelength VCSEL, comprising:
an indium-based semiconductor alloy substrate;
a first mirror stack over the substrate;
an active region having a plurality of quantum wells over the first mirror stack; and
a second mirror stack over the active region,
wherein either or both of the first and second mirror stacks include alternating layers of II-VI and III-V compounds, and wherein said II-VI compound is selected from the group consisting of ZnCdSe, ZnSeTe and ZnMgSe, and said III-V compound is selected from the group consisting of InGaAsP, InAlGaAs and InP.

10. A long-wavelength VCSEL according to claim 9, further including a current confinement structure over the active region.

11. A long-wavelength VCSEL according to claim 10, wherein the current confinement structure includes an insulating region and a conductive annular center.

12. A long-wavelength VCSEL according to claim 10, further including a tunnel junction over the current confinement structure.

13. A long-wavelength VCSEL according to claim 9, wherein the alternating layers of II-VI and III-V compounds are grown by a MOCVD method using hydride sources like TBA and TBP at a temperature less than 600° C.

14. A long-wavelength VCSEL according to claim 9, wherein the alternating layers of II-VI and III-V compounds are grown by a MBE method.

15. A long-wavelength VCSEL according to claim 12, wherein the first and second mirror stacks are an n-type DBR.

16. A long-wavelength VCSEL according to claim 15, wherein the active region includes one of InGaAsP, AlInGaAs, and InP.

17. A vertical cavity surface emitting laser, comprising:
a substrate;
a first mirror stack over the substrate having a plurality of distributed Bragg reflector layers, the distributed Bragg reflector layers including a plurality of first layers that alternate with a plurality of second layers, wherein the plurality of first layers is a II-VI compound and the plurality of second layers is a III-V compound;
an active region having a plurality of quantum wells; and
a second mirror stack over the active region, the second mirror stack having a plurality of distributed Bragg reflector layers, the distributed Bragg reflector layers including a plurality of first layers that alternate with a plurality of second layers, wherein the plurality of first layers is a II-VI compound and the plurality of second layers is a III-V compound.

18. A vertical cavity surface emitting laser according to claim 17, wherein the II-V compound of the plurality of first layers in the first mirror stack and in the second mirror stack is one of ZnCdSe, ZnSeTe, and AnMgSe.

19. A vertical cavity surface emitting laser according to claim 17, wherein the III-V compound of the second plurality of layers of the first mirror stack and in the second mirror stack is one of InGaAsP, InAlGaAs, and InP.

20. A vertical cavity surface emitting laser according to claim 17, wherein the first mirror stack includes less than 40 Bragg reflector layers and wherein the second mirror stack includes less than 40 Bragg reflector layers.

21. A vertical cavity surface emitting laser according to claim 20, wherein light having a wavelength greater than 1.3 μm is reflected between the first mirror stack and the second mirror stack.
